(19) United States
(12) Patent Application Publication
(10) Pub. No.: US 2006/0217095 A1
(43) Pub. Date: Sep. 28, 2006

(54) Wideband tuning circuit

(76) Inventor: Takatsuga Kamata, Yokohama (JP)

Correspondence Address: STATTLER JOHANSEN & ADELI, P O BOX 51860, PALO ALTO, CA, 94303, US

(21) Appl. No.: 11/373,555

(22) Filed: Mar. 10, 2006

Related U.S. Application Data
(60) Provisional application No. 60/661,112, filed on Mar. 11, 2005.

(51) Int. Cl. H04B 1/18

(52) U.S. Cl. 455/165.1

(57) ABSTRACT

Some embodiments provide an oscillator that produces a signal at a desired frequency for use in a tuner. The oscillator comprises a filter and a frequency divider circuit comprising one or more frequency dividers in sequence, each frequency divider reducing a received frequency by a predetermined proportion. The frequency of the oscillator is controlled by a tuning code comprising a fine tuning code applied to the filter and a coarse tuning code applied to the frequency divider circuit. The filter is used to produce an initial frequency according to the fine tuning code and the frequency divider circuit divides down the initial frequency according to the coarse tuning code to produce a final frequency of the oscillator. Some embodiments provide an automated method and apparatus for tuning the oscillator to produce a signal at a desired frequency where the coarse tuning code is determined before the fine tuning code.

### CROSS-REFERENCES TO RELATED APPLICATIONS

This application claims the benefit of U.S. Provisional Patent Application No. 60/661,112, filed Mar. 11, 2005, entitled “A Wideband Tuning Circuit.”

### FIELD OF THE INVENTION

The present invention is directed towards the field of oscillators used in tuning circuits.

### BACKGROUND OF THE INVENTION

Wide band receivers are designed to process input signals with a wide range of input carrier frequencies. For example, television receivers must be capable of processing input television signals with carrier frequencies ranging from 55 MHz to 880 MHz. Typically, receivers employ filters to condition both input signals and internally generated reference signals. For example, bandpass, notch, and low pass are types of filters employed in receivers. The frequency response of a filter refers to the characteristics of the filter that condition the signal input to the filter. For example, a bandpass filter may attenuate an input signal across a pre-determined band of frequencies above and below a center frequency of the filter. Filters are designed to exhibit frequency responses based on one or more circuit parameters. One circuit parameter used to define the frequency response of a filter is the carrier frequency of an input signal. Also, receivers employ a local oscillator to produce a signal for mixing with the conditioned input signal to produce a carrier signal at an intermediate frequency.

As such, since wide band receivers process input signals with a wide range of input carrier frequencies, wide band receivers require tunable filters to process the wide band of input frequencies as well as a local oscillator capable of producing a mixing signal having a broad range (wide band) of frequencies. The local oscillator typically comprises two or more oscillators (e.g., voltage controlled oscillators) to produce mixing signals having such a broad range of frequencies. A conventional local oscillator having two or more oscillators, however, requires a large area of space on a circuit. Voltage controlled oscillators (VCOs) in particular occupy a large area as they typically comprise a plurality of inductors which are large in size.

Therefore, there is a need for a local oscillator that requires a smaller area of space on a circuit yet is able to produce a mixing signal having a wide band of frequencies.

### SUMMARY OF THE INVENTION

Some embodiments provide a local oscillator that produces a mixing signal at a desired frequency for use in a tuning circuit. The local oscillator is able to produce a mixing signal having a broad range of frequencies. The local oscillator comprises a tunable filter, a filter oscillator, and a frequency divider circuit. The frequency of the local oscillator is controlled by a tuning code comprising a fine tuning code applied to the tunable filter and a coarse tuning code applied to the frequency divider circuit. The tunable filter and filter oscillator are used to produce a signal with an initial frequency for the local oscillator. The filter can be tuned to produce a range of initial frequencies using the fine tuning code. The frequency divider circuit receives the signal with the initial frequency and divides down/reduces the initial frequency to produce a signal with a final frequency for the local oscillator. The amount of frequency reduction of the initial frequency by the frequency divider circuit (the number of times the initial frequency is divided down by the frequency divider circuit) is determined by the coarse tuning code.

In some embodiments, the frequency divider circuit comprises one or more frequency dividers in sequence, each frequency divider reducing a received frequency by a predetermined proportion. Each frequency divider includes a selection switch. As a signal passes through each frequency divider in sequence, the frequency of the signal continues to be reduced by a predetermined proportion associated with each frequency divider until the signal reaches an activated selection switch of a frequency divider, whereupon the final frequency of the local oscillator is produced. The initial frequency is divided down to the final frequency using a coarse tuning code that selects a particular frequency divider (and activates the selection switch of the particular frequency divider).

Some embodiments provide for an automated method and apparatus for tuning the local oscillator to produce a mixing signal at a desired frequency. The automated method comprises determining a tuning code (having a predetermined number of bits), the tuning code comprising a coarse/primary tuning code and a fine/secondary tuning code. Using the tuning code, the local oscillator can be tuned across an overall frequency range (from a highest possible frequency to a lowest possible frequency). The coarse tuning code (having one or more bits) provides coarse tuning of the local oscillator by selecting a particular frequency divider of the frequency divider circuit. Each frequency divider of the frequency divider circuit has an associated frequency sub-range within the overall frequency range of the local oscillator. As such, the coarse tuning code, in effect, selects a particular frequency sub-range (from two or more possible frequency sub-ranges) within the overall frequency range of the local oscillator 125.

After the coarse tuning code is determined and set (and thus the frequency range that contains the desired frequency determined), the fine tuning code (having one or more bits) is determined to produce a resulting frequency of the local oscillator that matches the desired frequency. The fine tuning code tunes the tunable filter to produce the initial frequency of the local oscillator that is later divided down by the frequency divider circuit to produce the final frequency that matches the desired frequency. The tuning code (comprising the coarse and fine tuning codes) is adjusted and set using the automated tuning method and apparatus that compares and adjusts the resulting frequency of the local oscillator (via the tuning code) until it matches the desired frequency.

In some embodiments, the local oscillator is used in a tuning circuit (e.g., television tuner) for processing received RF signals. In some embodiments, the local oscillator outputs an in-phase signal and a quadrature phase signal having the desired frequency.

### BRIEF DESCRIPTION OF THE DRAWINGS

FIG. 1 is a block diagram illustrating a television tuner in which some embodiments are implemented.

FIG. 2 is a block diagram illustrating the local oscillator and the automated tuning circuit of FIG. 1 of some embodiments.

FIG. 3 is a block diagram showing detail of an exemplary local oscillator.

FIG. 4 is a flow diagram illustrating a successive approximation process for tuning a local oscillator to a desired frequency.

FIG. 5 is a flow diagram illustrating an alternative process 500 for tuning a local oscillator to a desired frequency

FIG. 6 is a graph that shows an example of the relationship between the oscillation frequency of an increasing filter and the value of the fine tuning code.

FIG. 7 is a graph that shows an example of the relationship between the oscillation frequency of a decreasing filter and the value of a fine tuning code.

### DETAILED DESCRIPTION

The disclosures of U.S. Provisional Patent Application No. 60/661,112, filed Mar. 11, 2005, entitled “A Wideband Tuning Circuit” and U.S. patent application Ser. No. 10/448,605, filed May 29, 2003, entitled “Methods and Apparatus for Tuning Using Successive Approximation,” are hereby expressly incorporated herein by reference.

Although the present invention is described below in terms of specific exemplary embodiments, one skilled in the art will realize that various modifications and alterations may be made to the below embodiments without departing from the spirit and scope of the invention. For example, a local oscillator of a television tuner are described below. One skilled in the arts will realize, however, that the local oscillator can also be used in other types of tuners. Also, some embodiments relate to specific types of filters. It should be appreciated, however, that these embodiments may relate to any filter that exhibits monotonically increasing or monotonically decreasing oscillation frequencies as a fine tuning code (used to vary the frequency of the filter) increases in value.

In the discussion below, Section I describes a general tuning circuit in which some embodiments are implemented. Section II describes in detail a local oscillator used in the tuning circuit and an automated tuning circuit used to tune the local oscillator to a desired frequency. Section III describes an automated tuning process used to tune the local oscillator to the desired frequency. And Section IV describes different types of filters that may be used in the local oscillator.

I. Tuning Circuit

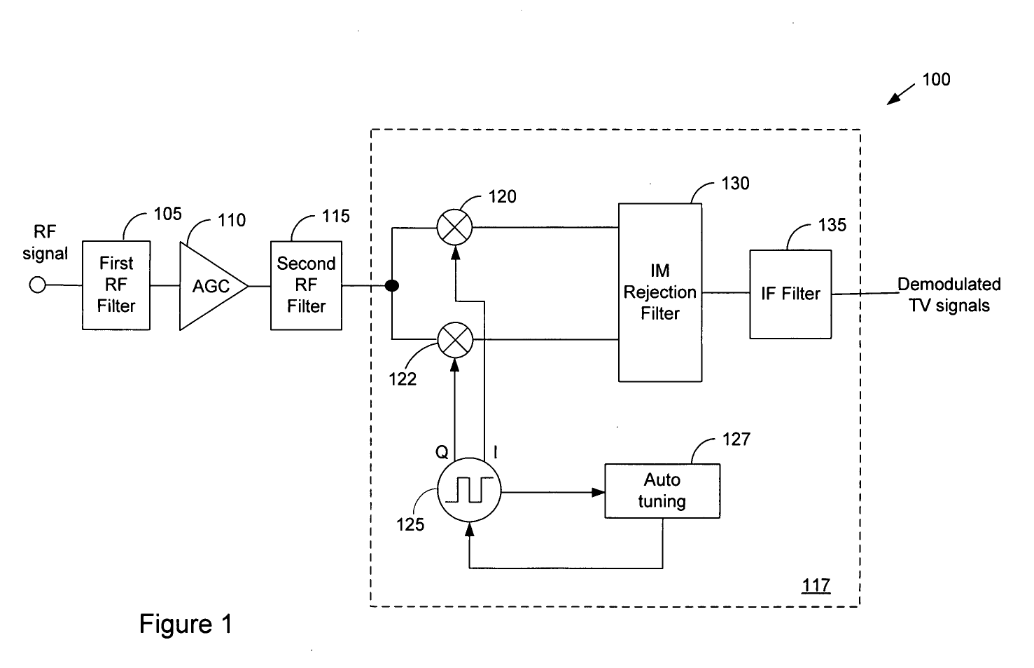

FIG. 1 is a block diagram illustrating a television tuner 100 in which some embodiments are implemented. The television tuner 100 receives a radio frequency (“RF”) television signal, and generates demodulated baseband television signals (i.e., picture and sound signals). For this embodiment, television tuner 100 includes a first RF filter 105, an automatic gain control circuit (AGC) 110, a second RF filter 110, and a quadratic down converter 117. The RF filters 105 and 115 (e.g., LC filters comprising inductive and capacitive banks) are tuned to a desired frequency (equal to the channel frequency of a selected television channel) and used to provide a band pass filter function for the television receiver 100. The AGC 110 is coupled between the first and second RF filters and amplifies the signal, output from the first RF filter 105, for input to the second RF filter 115.

The quadratic down converter 117 comprises an I mixer 120, a Q mixer 122, a local oscillator 125, an automated tuning circuit 127, an image rejection filter (notch filter) 130, and an intermediate frequency (IF) filter (band pass filter) 135. In some embodiments, the local oscillator 125 comprises a voltage controlled oscillator (VCO). The quadratic down converter 117 converts the frequency of the filtered RF television signal to an immediate frequency (IF) that is determined by country standards. Generally, a down converter mixes an input signal with a local oscillator signal to produce the IF signal. For a quadratic down converter, the local oscillator 125 produces an in-phase (“I”) local oscillator signal and a quadrature phase (“Q”) local oscillator signal. The Q local oscillator signal is phase shifted 90 degrees from the I local oscillator signal. Also for a quadratic down converter, a quadratic demodulator splits the input signal (by duplicating the input signal), and mixes (at I mixer 120) one duplicate input signal with an in-phase local oscillator signal and mixes (at Q mixer 122) the other duplicate input signal with the quadrature phase local oscillator signal.

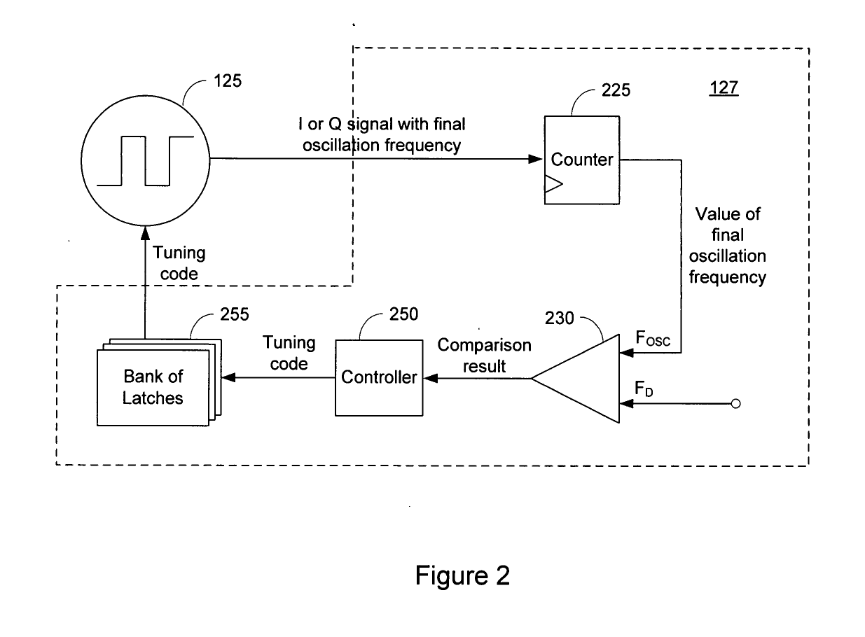

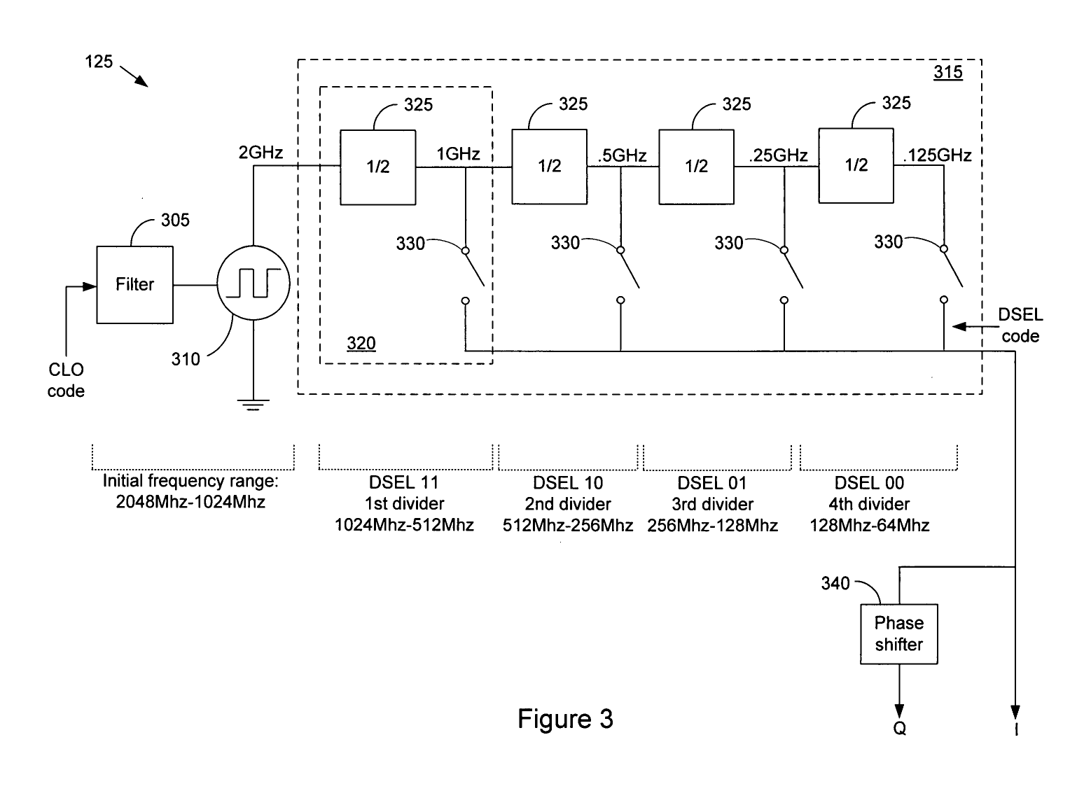

The I and Q signals generated by the local oscillator 125 and the RF signal from the second RF filter 115 (the RF signal being filtered to the channel frequency) is received by the mixers 120 and 122, respectively. Note that although phase shifted by 90 degrees, the I and Q signals have the same oscillation frequency. The mixers 120 and 122 mix the received signals to produce a carrier signal at an intermediate frequency. In some embodiments, the desired frequency to which the local oscillator 125 is to be tuned (i.e., the desired frequency of the generated I and Q signals) is equal to the channel frequency (i.e., the frequency of the signal from the input RF signal) plus the intermediate frequency. In other embodiments, the desired frequency of local oscillator 125 is equal to the channel frequency minus the intermediate frequency. In further embodiments, the desired frequency of local oscillator 125 is equal to any other frequency. The automated tuning circuit 127 automatedly tunes the local oscillator 125 to the desired frequency (as discussed below in relation to FIGS. 2 and 3).

The image rejection notch filter 130 receives the mixed signals produced by the I mixer 120 and the Q mixer 122. The image rejection filter 130 is tuned to the intermediate frequency and filters out the image in the received signals. The IF band pass filter 135 receives the signal from the image rejection notch filter 130. The IF band pass filter 135 is tuned to the intermediate frequency and attenuates signals at frequencies other than around the intermediate frequency (IF).

II. Local Oscillator and Automated Tuning Circuit

FIG. 2 is a block diagram illustrating the local oscillator 125 and the automated tuning circuit 127 of FIG. 1 of some embodiments. The automated tuning circuit 127 automatedly tunes the local oscillator 125 to a desired frequency. The automated tuning circuit 127 comprises a counter 225, a comparator 230, a controller 250, and a bank of latches 255 that are coupled together in a feedback loop with the local oscillator 125.

FIG. 3 is a block diagram showing detail of an exemplary local oscillator 125. In some embodiments, the local oscillator 125 comprises a VCO. The local oscillator 125 produces a mixing signal at a desired frequency, the local oscillator being able to produce a mixing signal having a broad range of frequencies. The local oscillator 125 comprises a tunable filter 305, a filter oscillator 310, and a frequency divider circuit 315. The frequency of the local oscillator 125 is controlled by a tuning code comprising a fine tuning code (CLO code) that is applied to the filter 305 and a coarse tuning code (DSEL code) that is applied to the frequency divider circuit 315. Using the tuning code, the local oscillator can be tuned across an overall frequency range (from a highest possible frequency to a lowest possible frequency).

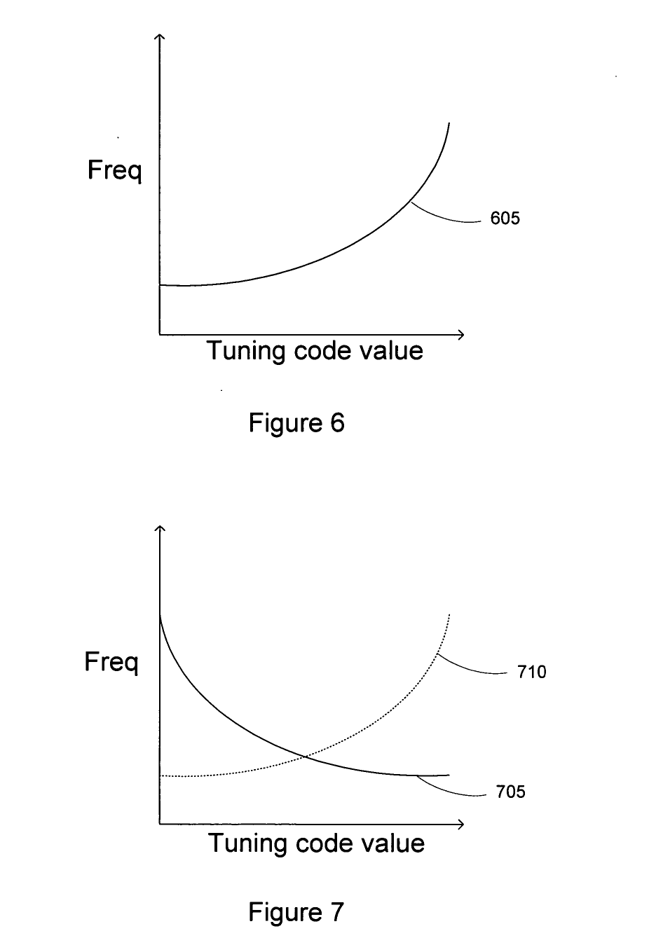

The filter 305 and filter oscillator 310 are used to produce a signal with an initial frequency for the local oscillator. Using the fine tuning code, the filter 305 can be tuned to produce a range of initial frequencies (from a highest possible initial frequency to a lowest possible initial frequency). In some embodiments, the fine tuning code is applied to the filter to produce a corresponding resonant frequency. In some embodiments, the fine tuning code is applied to switches contained in the filter 305 to select or deselect elements (such as resistors or capacitors) in the filter 305. A specific fine tuning code selects and deselects specific elements in the filter 305 so that the filter 305 produces a signal having a resonant frequency at a specific frequency. For example, if the filter 305 is an RC filter, resistors in the RC filter are selected through switches according to the fine tuning code. If the filter 305 is an LC filter, capacitors in the LC filter are selected through switches according to the fine tuning code. Various embodiments of the filter 305 are discussed below in relation to FIGS. 6 and 7.

The frequency divider circuit 315 receives the signal having the initial frequency from the filter 305 and filter oscillator 310 and divides down/reduces the initial frequency to produce a signal having final frequency for the local oscillator. The frequency divider circuit 315 comprises one or more frequency dividers 320 in sequence, each frequency divider reducing the frequency of a received input signal by a predetermined proportion (where the output frequency of the frequency divider=input frequency*1/N). The number of frequency dividers dividing down the initial frequency (and thus the overall amount of frequency reduction of the initial frequency) is determined by the coarse tuning code.

In the example shown in FIG. 3, the frequency divider circuit 315 comprises four “divide by two” frequency dividers, each frequency divider reducing a received frequency by half (where N=2). As such, the frequency divider circuit can divide down the initial frequency by two, four, eight, or sixteen. In other embodiments, the frequency divider circuit 315 comprises a different number of frequency dividers and/or frequency dividers that reduce a frequency of a received input signal by a different proportion. In other embodiments, two frequency dividers of the frequency divider circuit reduce a received frequency by a different proportion amount (e.g., where one frequency divider divides down a received frequency by half and another frequency divider divides down a received frequency by a third).

Each frequency divider 320 includes a divider 325 and a selection switch 330. As a signal passes through each frequency divider 320 in sequence, the frequency of the signal continues to be reduced by a predetermined proportion until the signal reaches an activated selection switch of a frequency divider, whereupon the signal is “pulled up” and output by the activated frequency divider which produces an output signal having the final frequency of the local oscillator. The coarse tuning code selects one particular frequency divider (by activating the selection switch of the particular frequency divider) among all the frequency dividers in the frequency divider circuit 315 to output the signal.

In some embodiments, the coarse tuning code comprises two bits of the tuning code: the most significant bit (MSB) and the second most significant bit of the tuning code. In these embodiments, the two bits of the coarse tuning code are used to select one frequency divider among four frequency dividers of the frequency divider circuit 315 for outputting a signal. For example, as shown in the exemplary frequency divider circuit 315 of FIG. 3, a coarse tuning code (DSEL code) equal to 11 would select the first frequency divider on the far left for outputting a signal, whereas a coarse tuning code equal to 00 would select the fourth frequency divider on the far right for outputting a signal.

The coarse tuning code provides coarse tuning of the local oscillator by selecting a particular frequency divider of the frequency divider circuit. This in effect selects for the final frequency of the local oscillator a particular frequency sub-range (associated with the selected frequency divider) within the overall frequency range of the local oscillator 125. For example, using the fine tuning code, assume that the filter 305 and filter oscillator 310 can produce a range of initial frequencies from 2048 Mhz (produced by fine tuning code 111111) to 1024 Mhz (produced by fine tuning code 000000). Therefore, in the exemplary frequency divider circuit 315 of FIG. 3, a coarse tuning code equal to 10 would select the second frequency divider which would have an associated frequency sub-range of 512 Mhz to 256 Mhz. This means that regardless of what the fine tuning code is set to, the final frequency of the local oscillator will be within the frequency sub-range of 512 Mhz to 256 Mhz. This is true since the highest frequency produced by the highest value (111111) of the fine tuning code is 2048 Mhz. When divided down by half by the first frequency divider and again divided down by half by the second frequency divider, the resulting final frequency of the local oscillator would be 512 Mhz. Similarly, the lowest frequency produced by the lowest value (000000) of the fine tuning code is 1024 Mhz. When divided down by the first and second frequency dividers, the resulting final frequency of the local oscillator would be 256 Mhz.

An example of the operation of the frequency divider circuit 315 is shown in FIG. 3. In this example, the filter 305 and filter oscillator 310 produce an initial frequency of 2 GHz. If the first frequency divider is selected (DSEL=11), the final frequency of the local oscillator 125 would be 1 GHz. If the second frequency divider is selected (DSEL=10), the final frequency of the local oscillator 125 would be 0.5 GHz. If the third frequency divider is selected (DSEL=01), the final frequency of the local oscillator 125 would be 0.25 GHz. If the fourth frequency divider is selected (DSEL=00), the final frequency of the local oscillator 125 would be 0.125 GHz.

The frequency divider circuit 315 outputs I and Q signals having the final frequency of the local oscillator 125. The Q signal is generated by the phase shifter 340 which produces a signal that is phase shifted by 90 degrees from the I signal. Note that although phase shifted by 90 degrees, the I and Q signals have the same oscillation frequency and either can be used for measurement by the counter 225 (as discussed further below).

Referring back to FIG. 2, the automated tuning circuit 127 automatedly tunes the local oscillator 125 to a desired frequency. In each iteration of the feedback loop (comprising the counter 225, comparator 230, controller 250, and bank of latches 255), the controller 250 generates a tuning code using a tuning algorithm. The tuning code is a digital code that determines the frequency of the local oscillator 125 (as discussed above). In some embodiments, the tuning algorithm is a successive approximation algorithm. Details of the successive approximation tuning algorithm are discussed in U.S. patent application Ser. No. 10/448,605, filed May 29, 2003, entitled “Methods and Apparatus for Tuning Using Successive Approximation,” expressly incorporated herein by reference.

The tuning code produced by the controller 250 is sent to the bank of latches 255 where it is stored. The tuning code comprises a fine tuning code that is applied to the filter 305 and coarse tuning code that is applied to the frequency divider circuit 315. In some embodiments, the filter 305 exhibits monotonically increasing oscillation frequencies as the fine tuning code increases in value (such as an RC filter). In other embodiments, the filter 305 exhibits monotonically decreasing oscillation frequencies as the fine tuning code increases in value (such as an LC filter).

The tuning code is then sent from the bank of latches 255 to the local oscillator 125. The local oscillator 125 then produces I and Q signals with an oscillation frequency that is determined by the tuning code. Either the I or Q signal produced by the local oscillator 125 is then sent to the counter 225 which measures the oscillation frequency (F_{OSC}) of the I or Q signal. The oscillation frequency (F_{OSC}) of the I or Q signal is sent to the comparator 230. The comparator 230 also receives the desired frequency (F_{D}) to which the local oscillator 125 is supposed to be tuned and compares the two received frequencies.

If the filter 305 is a filter that exhibits monotonically increasing oscillation frequencies as the fine tuning code increases in value (such as an RC filter), the comparator 230 determines if the oscillation frequency (F_{OSC}) is greater than the desired frequency (F_{D}). If the filter 305 is a filter that exhibits monotonically decreasing oscillation frequencies as the fine tuning code increases in value (such as an LC filter), the comparator 230 determines if the oscillation frequency (F_{OSC}) is less than the desired frequency (F_{D}). The comparator 230 sends an affirmative signal (e.g., a signal having a value of 1) or a negative signal (e.g., a signal having a value of 0) to the controller 250 depending on the results of the comparison.

The controller 250 receives the affirmative or negative signal from the comparator 230 and produces a modified tuning code using the affirmative or negative signal and the tuning algorithm. In some embodiments, the tuning algorithm uses successive approximation to continually modify the tuning code until each bit of the tuning code has been determined. Recall that the tuning code comprises a fine tuning code that is applied to the tunable filter and a coarse tuning code that is applied to the frequency divider circuit. In some embodiments, the coarse tuning code comprises the MSB and second MSB of the tuning code and the fine tuning code comprises the remaining bits of the tuning code. In some embodiments, the tuning algorithm determines and sets the coarse tuning code first. After the coarse tuning code is determined and set (and thus the frequency range that contains the desired frequency determined), each bit of the fine tuning code (from the most significant bit to the least significant bit) is determined and set to produce a resulting frequency of the local oscillator that matches the desired frequency.

III. Automated Tuning Process

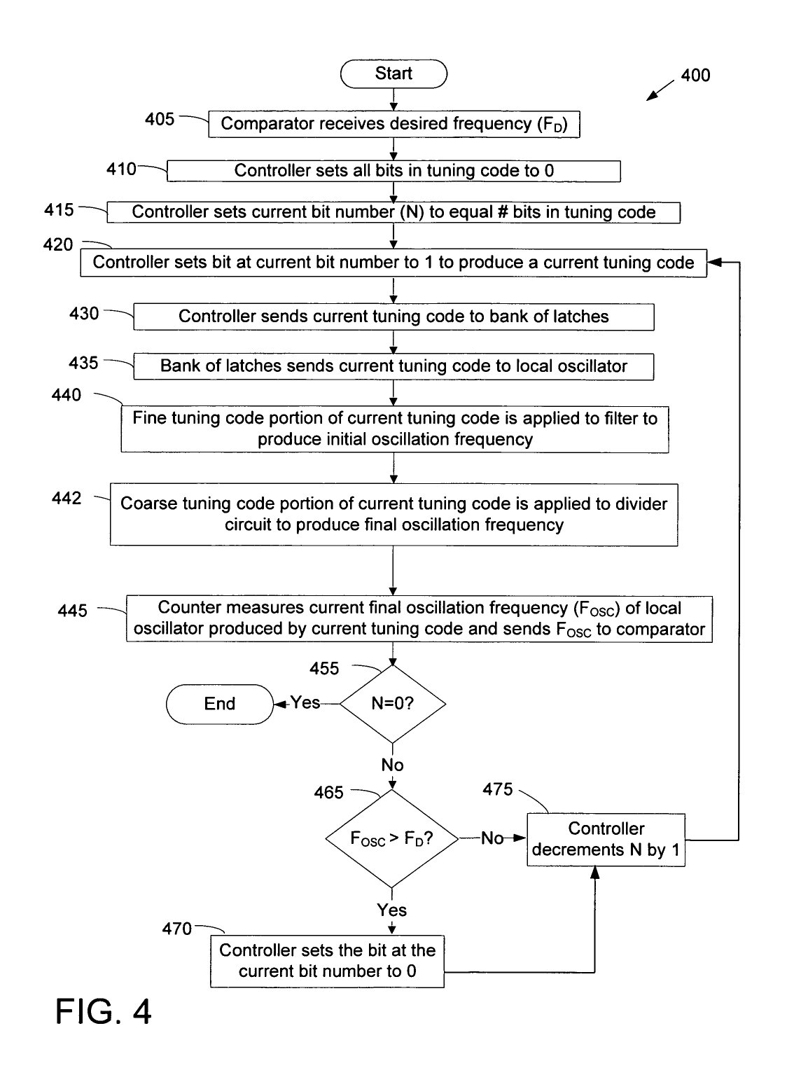

FIG. 4 is a flow diagram illustrating a successive approximation process 400 for tuning a local oscillator to a desired frequency, the local oscillator having a filter that exhibits monotonically increasing oscillation frequencies as the fine tuning code increases in value (such as an RC filter). In some embodiments, the process 400 is implemented by software or hardware configured for tuning the local oscillator to the desired frequency. In some embodiments, the steps of process 400 are performed by the controller 250.

The process 400 is started when the comparator receives (at 405) a desired frequency (F_{D}) to which the local oscillator is to be tuned. A controller then sets (at 410) all bits in a tuning code to 0. The tuning code comprises a coarse tuning code (comprising one or more bits) that is applied to the frequency divider circuit and a fine tuning code (comprising one or more bits) that is applied to the filter. In some embodiments, the tuning code comprises eight bits, wherein the coarse tuning code comprises the MSB and second MSB of the tuning code and the fine tuning code comprises the remaining six bits of the tuning code.

The controller also sets (at 415) a current bit number (N) to equal the number of bits in the tuning code (e.g., eight). The bits of the tuning code have positions in the tuning code numbered from the least significant bit (e.g., having a position number of 1) to the most significant bit (e.g., having a position number of 8 for a 8 bit tuning code). The controller then sets to 1 (at 420) the bit having a position number in the tuning code equal to the current bit number (N) in order to produce a current tuning code.

For example, for the first iteration of the process 400, for an 8 bit tuning code, N equals 8. As such, the bit in the tuning code having a position number of 8 (i.e., the MSB of the tuning code) would be set to equal 1. Note that in some embodiments, the process 400 begins by first determining and setting the MSB, then the second MSB, and then the remaining bits of the tuning code. As such, in these embodiments, the process 400 first determines and sets the coarse tuning code to select a particular frequency divider of the frequency divider circuit and a particular frequency sub-range containing the desired frequency. The process 400 then continues to determine and set the fine tuning code bit-by-bit to tune the final frequency of the local oscillator to match the desired frequency.

The controller then sends (at 430) the current tuning code to a bank of latches for storage. The bank of latches then sends (at 435) the current tuning code to the local oscillator. The fine tuning code portion of the current tuning code is applied (at 440) to the filter to produce a signal with an initial frequency. In particular, elements in the filter are selected or deselected according to the current fine tuning code that causes the filter to oscillate at a current initial oscillation frequency. The coarse tuning code portion of the tuning code is applied (at 442) to the frequency divider circuit to divide down/reduce the initial frequency to produce a signal with a current final oscillation frequency (F_{OSC}) of the local oscillator.

A counter measures (at 445) the current oscillation frequency (F_{OSC}) produced by the current tuning code and sends the measured value of the current oscillation frequency (F_{OSC}) to the comparator. The controller then checks (at 455) if the value of the current bit number (N) is equal to the position number of the least significant bit of the tuning code minus 1. For example, the controller checks (at 455) if the value of the current bit number (N) is equal to 0 if the position number of the least significant bit is 1. If so, the process 400 ends.

If the value of the current bit number (N) is not equal to 0 (at 455-No), the comparator determines (at 465) if the current oscillation frequency (F_{OSC}) of the local oscillator is greater than the desired frequency (F_{D}). If so, the controller sets to 0 (at 470) the bit having a position number in the tuning code equal to the current bit number (N). The controller then decrements (at 475) the current bit number (N) by 1, i.e., N is set to equal N-1. If the comparator determines that the current oscillation frequency (F_{OSC}) is not greater than the desired frequency (F_{D}) (at 465-No), the controller decrements (at 475) the current bit number (N) by 1.

The process 400 continues at step 420 where the controller sets to 1 the bit having a position number in the tuning code equal to the current bit number (N) to produce a current tuning code. The process repeats steps 420 through 475 until the current bit number (N) is equal to the position number of the least significant bit of the tuning code minus 1. Therefore, the process 400 continues using successive approximation to determine the value of each bit of the tuning code from the MSB to the least significant bit (LSB). By doing so, the process 400 converges on the value of the tuning code that produces an oscillation frequency in the local oscillator that is closest to the desired frequency (with a maximum error of 1 least significant bit).

The local oscillator 125 of FIG. 3 can be used to illustrate an example of the tuning process 400. In this example, assume the following:
an 8 bit tuning code is used, the MSB and second MSB comprising the coarse tuning code and the remaining 6 bits comprising the fine tuning code;
the filter 305 and filter oscillator 310 can be tuned to produce an initial frequency between 2048 Mhz to 1024 Mhz, wherein the filter exhibits monotonically increasing oscillation frequencies as the fine tuning code increases in value so that the highest frequency (2048 Mhz) is produced by the highest value (111111) of the fine tuning code and the lowest frequency (1024 Mhz) is produced by the lowest value (000000) of the fine tuning code;
after the initial frequency is divided down by the frequency divider circuit 315, the final frequency of the local oscillator 125 has an overall frequency range from 1024 Mhz to 64 Mhz;
the overall frequency range has a frequency sub-range of 1024 Mhz to 512 Mhz associated with a first frequency divider (selectable by coarse tuning code 11), a frequency sub-range of 512 Mhz to 256 Mhz associated with a second frequency divider (selectable by coarse tuning code 10), a frequency sub-range of 256 Mhz to 128 Mhz associated with a third frequency divider (selectable by coarse tuning code 01), and a frequency sub-range of 128 Mhz to 64 Mhz associated with a fourth frequency divider (selectable by coarse tuning code 00) of the frequency divider circuit 315; and
the desired frequency is 210 MHz.

Therefore, the current bit number (N) is equal to 8, the LSB of the tuning code has a position numbered 1, and the MSB of the tuning code has a position numbered 8. The process 400 sets all bits to 0 and sets to 1 the bit at position number 8 to produce a current tuning code of 10000000 (where the coarse tuning code equals 10 and the fine tuning code equals 000000). The fine tuning code 000000 is applied to the filter 305 and produces a signal with the initial frequency of 1024 Mhz. The coarse tuning code of 10 selects the second frequency divider (by activating the switch in the second frequency divider). As such, the initial frequency of the signal is divided down by half by the first frequency divider and again divided down by half by the second frequency divider before the signal is “pulled up” (due to the activated switch of the second frequency divider) and output from the local oscillator with a final oscillation frequency of 256 Mhz.

Since the current oscillation frequency of 256 Mhz is greater than the desired frequency of 210 MHz, the process 400 sets to 0 the bit at position 8 in the tuning code. The process 400 then decrements the current bit number (N) to 7 and sets to 1 the bit at position number 7 to produce a current tuning code of 01000000 (where the coarse tuning code equals 01 and the fine tuning code equals 000000). The fine tuning code 000000 is applied to the filter 305 and produces a signal with the initial frequency of 1024 Mhz. The coarse tuning code of 01 selects the third frequency divider. As such, the initial frequency of the signal is divided down by half by the each of the first, second, and third frequency dividers before the signal is “pulled up” and output from the local oscillator with a final oscillation frequency of 128 Mhz.

Since the current oscillation frequency of 128 Mhz which is less than the desired frequency of 210 MHz, the process 400 decrements the current bit number (N) to 6. At this point, the process 400 has determined and set the values for the coarse tuning code and now begins to determine the values for the fine tuning code. The coarse tuning code has been set to 01 which is correct since this selects the third frequency divider having an associated frequency range of 256 Mhz to 128 Mhz (which contains the desired frequency of 210 Mhz).

The process 400 then sets to 1 the bit at position number 6 (i.e., the MSB of the fine tuning code) to produce a current tuning code of 01100000 (where the coarse tuning code equals 01 and the fine tuning code equals 100000). The fine tuning code 100000 is applied to the filter 305 and produces, for example, a signal with the initial frequency of 1400 Mhz. The coarse tuning code of 01 causes the initial frequency to be divided down by 8 to produce a final oscillation frequency of 175 Mhz.

Since the final oscillation frequency of 175 Mhz is less than the desired frequency of 210 MHz, the process 400 decrements the current bit number to 5 and sets to 1 the bit at position number 5 to produce a current tuning code of 01110000 (where the coarse tuning code equals 01 and the fine tuning code equals 110000). The fine tuning code 110000 is applied to the filter 305 and produces, for example, a signal with the initial frequency of 1800 Mhz. The coarse tuning code of 01 causes the initial frequency to be divided by 8 to produce a final oscillation frequency of 225 Mhz.

The process 400 continues to compare the final oscillation frequency to the desired frequency and adjust the tuning code according to the results of the comparison (as illustrated in FIG. 4) until the process 400 determines and sets each bit of the tuning code. The final tuning code determined by the process causes the local oscillator 125 to produce an oscillation frequency which is the closest oscillation frequency to the desired frequency with a maximum error of 1 least significant bit of the tuning code.

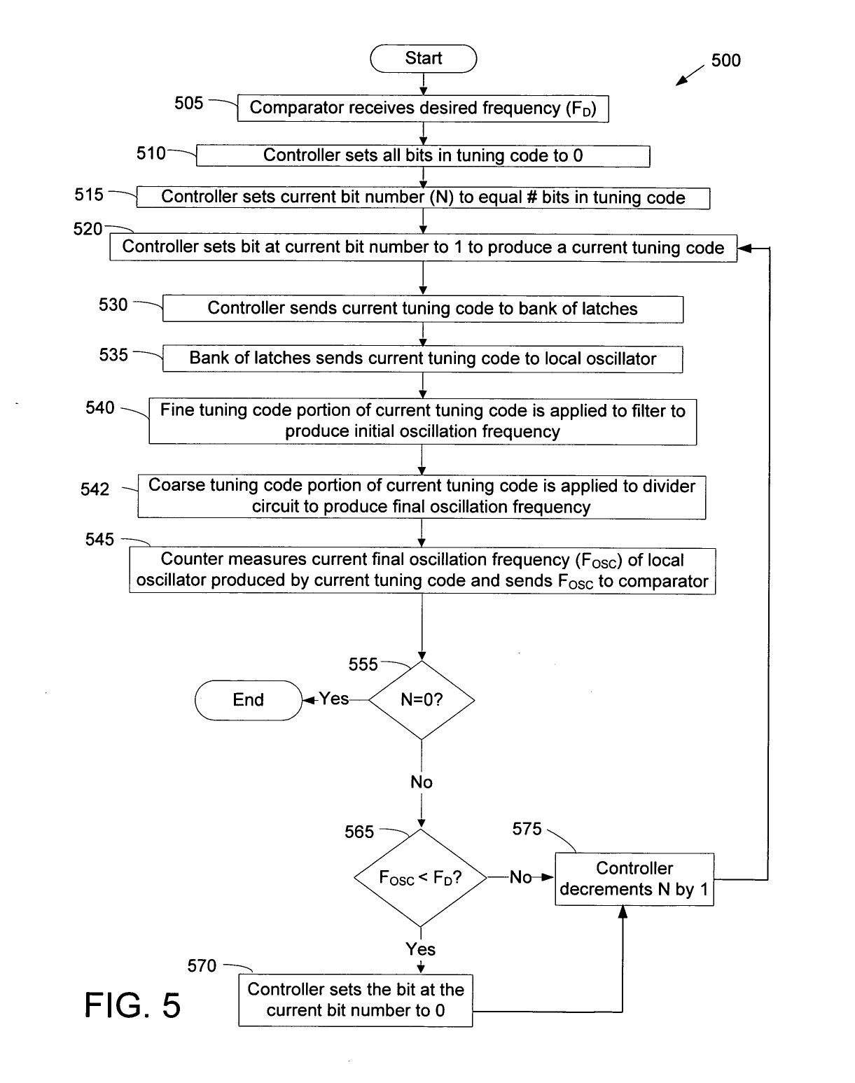

FIG. 5 is a flow diagram illustrating a process 500 for tuning a local oscillator to a desired frequency, the local oscillator having a filter that exhibits monotonically decreasing oscillation frequencies as the tuning code increases in value (such as an LC filter). In some embodiments, the process 500 is implemented by software or hardware configured for tuning the local oscillator to the desired frequency. In some embodiments, the steps of process 500 are performed by the controller 250. The process 500 for tuning an local oscillator shown in FIG. 5 is similar to the process 400 shown in FIG. 4 and only those steps that differ are discussed in detail here.

The process 500 is started when a comparator receives (at 505) a desired frequency (F_{D}) to which the local oscillator is to be tuned. The controller sets (at 510) all bits in the tuning code to 0 and sets (at 515) a current bit number (N) to equal the number of bits in the tuning code. The controller then sets to 1 (at 520) the bit having a position number in the tuning code equal to the current bit number (N) in order to produce a current tuning code. The controller sends (at 530) the current tuning code to a bank of latches for storage.

The bank of latches then sends (at 535) the current tuning code to the local oscillator. The fine tuning code portion of the current tuning code is applied (at 540) to the filter to produce an initial frequency and the coarse tuning code portion of the tuning code is applied (at 542) to the frequency divider circuit to produce a current final oscillation frequency (F_{OSC}) of the local oscillator. A counter measures (at 545) the current oscillation frequency (F_{OSC}) and sends the value of the current oscillation frequency (F_{OSC}) to the comparator.

The controller then checks (at 555) if the value of the current bit number (N) is equal to 0. If so, the process 500 ends. If not, the comparator determines (at 565) if the current oscillation frequency (F_{OSC}) of the local oscillator is less than the desired frequency (F_{D}). If so, the controller sets to 0 (at 570) the bit having a position number in the tuning code equal to the current bit number (N). The controller then decrements (at 575) the current bit number (N) by 1. If the comparator determines that the current oscillation frequency (F_{OSC}) is not less than the desired frequency (F_{D}) (at 565-No), the controller decrements (at 575) the current bit number (N) by 1. The process 500 continues at step 520 and the process repeats steps 520 through 575 until the current bit number (N) is equal to 0.

Note that in the tuning process 400 of FIG. 4, the comparator determines (at 465) if the current oscillation frequency (F_{OSC}) of the local oscillator is greater than the desired frequency (F_{D}). This is in contrast to the tuning process 500 of FIG. 5 where the comparator determines (at 565) if the current oscillation frequency (F_{OSC}) of the local oscillator is less than the desired frequency (F_{D}). By simply changing the basis of the comparison between the oscillation frequency and the desired frequency, the process 400 of FIG. 4 used to tune a local oscillator having a filter producing an increasing oscillation frequency with an increasing tuning code can be easily adapted to tune a local oscillator having a filter producing a decreasing oscillation frequency with an increasing tuning code.

In an alternative embodiment, the process 400 of FIG. 4 is adapted to tune a local oscillator having a filter producing a decreasing oscillation frequency with an increasing tuning code by simply performing a bit-inversion step after step 420. In the alternative embodiment, the controller produces (at 420) the current tuning code and then inverts the bits of the tuning code. As described below, using inverted tuning code bits to select or deselect elements in a filter (such as an LC filter) of the local oscillator can cause the oscillation frequency of the filter to increase rather than decrease as the tuning code increases.

IV. Types of Filters Used in the Local Oscillator

The filter 305 used in the local oscillator 125 may be any filter that exhibits monotonically increasing oscillation frequencies as a fine tuning code applied to the filter increases in value (the filter being referred to as an “increasing filter”). The filter 305 used in the local oscillator 125 may also be any filter that exhibits monotonically decreasing oscillation frequencies as a fine tuning code applied to the filter increases in value (the filter being referred to as a “decreasing filter”).

FIG. 6 is a graph that shows an example of the relationship between the oscillation frequency of an increasing filter and the value of the fine tuning code. As the values of the fine tuning code increases, the oscillation frequency of the increasing filter increases along an oscillation curve 605. Note that as the fine tuning code increases, the oscillation frequency of an increasing filter increases monotonically, i.e., the oscillation frequency follows an oscillation curve 605 that always has a positive slope. In accordance with the present invention, any type of filter having an oscillation frequency that is monotonically increasing as the value of the fine tuning code increases may be tuned in the same manner as an increasing filter.

An example of an increasing filter is a resistive-capacitive (RC) filter comprising resistive and capacitive elements that determine its resonant frequency according to a fine tuning code. When the fine tuning code is applied to the RC filter, resistors are selected (i.e., added) or deselected (i.e., removed) from a resistive bank through a corresponding switch (e.g., metal oxide semiconductor transistors). The fine tuning code produces a particular combination of selected and deselected resistors in the resistive bank that causes the RC filter to exhibit a particular oscillation frequency.

FIG. 7 is a graph that shows an example of the relationship between the oscillation frequency of a decreasing filter and the value of the fine tuning code. As the values of the fine tuning code increases, the oscillation frequency of the decreasing filter decreases along an oscillation curve 705. Note that as the fine tuning code increases, the oscillation frequency of a decreasing filter decreases monotonically, i.e., the oscillation frequency follows an oscillation curve 705 that always has a negative slope. In accordance with the present invention, any type of filter having an oscillation frequency that is monotonically decreasing as the value of the fine tuning code increases may be tuned in the same manner as a decreasing filter.

The methods of the present invention may be easily adapted to use increasing filters or decreasing filters. In some embodiments, the method used to automatically tune a local oscillator with an increasing filter is adapted to use a decreasing filter by simply inverting the bits of the fine tuning code and using the inverted fine tuning code bits to select or deselect elements in the decreasing filter. By inverting the bits of the fine tuning code, the oscillation frequency of a decreasing filter increases along an inverted oscillation curve 710 as the values of the fine tuning code increases.

An example of an increasing filter is an inductive-capacitive (LC) filter comprising inductive and capacitive elements that determine its resonant frequency according to a fine tuning code. When the fine tuning code is applied to the LC filter, capacitors are selected (i.e., added) or deselected (i.e., removed) from a capacitor bank through a corresponding switch (e.g., metal oxide semiconductor transistors). The fine tuning code produces a particular combination of selected and deselected capacitors in the capacitor bank that causes the LC filter to exhibit a particular oscillation frequency.

One of ordinary skill will recognize that the invention can be embodied in other specific forms without departing from the spirit of the invention, even though the invention has been described with reference to numerous specific details. In view of the foregoing, one of ordinary skill in the art would understand that the invention is not to be limited by the foregoing illustrative details, but rather is to be defined by the appended claims.

What is claimed is:

1. A tuner circuit for receiving and processing a radio frequency (RF) signal, the tuner circuit comprising:
a local oscillator comprising:
a filter for producing an initial signal having an initial frequency; and
a frequency divider circuit for receiving the initial signal and dividing down the initial frequency of the initial signal to produce a final signal having a final frequency; and
a first mixer for receiving and mixing the final signal and the RF signal to produce an output signal having an intermediate frequency.

2. The tuner circuit of claim 1 wherein:
an oscillator tuning code comprising a fine tuning code and a coarse tuning code is applied to the local oscillator;
the fine tuning code comprises one or more bits of the oscillator tuning code and is applied to the filter for producing the initial signal having the initial frequency; and
the coarse tuning code comprises one or more bits of the oscillator tuning code and is applied to the frequency divider circuit for producing the final signal having the final frequency.

3. The tuner circuit of claim 2 wherein:
the filter exhibits monotonically increasing or monotonically decreasing frequencies as the fine tuning code increases in value.

4. The tuner circuit of claim 2 wherein:
the filter comprises a plurality of selectable elements; and
different fine tuning codes produce different combinations of selected elements in the filter to produce different initial frequencies of the initial signal.

5. The tuner circuit of claim 2 wherein:
the frequency divider circuit comprises a plurality of frequency dividers in sequence, each frequency divider for dividing down a frequency of an input signal by a predetermined proportion.

6. The tuner circuit of claim 5 wherein:
the coarse tuning code selects a particular frequency divider in the frequency divider circuit for outputting the final signal having the final frequency.

7. The tuner circuit of claim 6 wherein:
each frequency divider comprises a switch;
the coarse tuning code selects a particular frequency divider in the frequency divider circuit by activating the switch of the particular frequency divider; and
the frequency dividers in the frequency divider circuit continue to divide down the initial frequency of the initial signal until the initial signal reaches an activated switch and is output as the final signal having the final frequency.

8. The tuner circuit of claim 1, wherein the local oscillator produces an in-phase (“I”) signal and a quadrature (“Q”) phase signal each having the final frequency.

9. The tuner circuit of claim 8, wherein the first mixer is configured for receiving and mixing the I signal and the RF signal to produce an outputted I signal having the intermediate frequency, the tuner circuit further comprising:
a second mixer for receiving and mixing the Q signal and the RF signal to produce an outputted Q signal having the intermediate frequency.

10. The tuner circuit of claim 2, further comprising:
a tuning circuit for automatically tuning the local oscillator to produce the final signal at a desired frequency.

11. The tuner circuit of claim 10, wherein:
the tuning circuit tunes the local oscillator to the desired frequency by determining values of the oscillator tuning code bit-by-bit until the desired frequency is produced, the coarse tuning code portion of the oscillator tuning code being determined before the fine tuning code portion of the oscillator tuning code.

12. The tuner circuit of claim 11, wherein:
the local oscillator can be tuned across an overall frequency range from a highest possible frequency to a lowest possible frequency, the overall frequency range comprising a plurality of frequency sub-ranges; and
the coarse tuning code selects a particular frequency sub-range in the overall frequency range, the particular frequency sub-range containing the desired frequency.

13. The tuner circuit of claim 12, wherein:
the fine tuning code tunes the local oscillator to the desired frequency with a maximum error of 1 least significant bit of the fine tuning code.

14. The tuner circuit of claim 10, wherein:
the tuning circuit automatically tunes the local oscillator to the desired frequency using an algorithm based on successive approximation.

15. A method for processing a received radio frequency (RF) signal, the method comprising:
producing an initial signal having an initial frequency;
dividing down the initial frequency of the initial signal to produce a final signal having a final frequency; and
mixing the final signal and the RF signal to produce an output signal having an intermediate frequency.

16. The method of claim 15 wherein:
an oscillator tuning code comprises a fine tuning code and a coarse tuning code;
the initial signal having the initial frequency is produced using the fine tuning code portion of the oscillator tuning code; and
the final signal having the final frequency is produced using the coarse tuning code portion of the oscillator tuning code.

17. The method of claim 16, further comprising:
automatically determining the oscillator tuning code that produces a final signal at a desired frequency.

18. The method of claim 17, wherein automatically determining the oscillator tuning code comprises:
determining values of the oscillator tuning code bit-by-bit until the desired frequency is produced, wherein the coarse tuning code portion of the oscillator tuning code is determined before the fine tuning code portion of the oscillator tuning code.

19. The method of claim 18, wherein:
the oscillator tuning code produces an overall frequency range from a highest possible frequency to a lowest possible frequency, the overall frequency range comprising a plurality of frequency sub-ranges; and
the coarse tuning code selects a particular frequency sub-range in the overall frequency range, the particular frequency sub-range containing the desired frequency.

20. The method of claim 19, wherein:
the oscillator tuning code is determined using an algorithm based on successive approximation; and
the oscillator tuning code adjusts the final frequency to the desired frequency with a maximum error of 1 least significant bit of the oscillator tuning code.
